(19) United States
(12) Patent Application Publication
(10) Pub. No.: US 2026/0242961 A1
(43) Pub. Date: Aug. 20, 2026

(54) PROTON RICH IONIC FLUID AND COMPATIBILITY WITH COMMON MATERIALS

(71) Applicant: TegIPco, LLC, Dover, DE (US)

(72) Inventors: Nicholas Joseph Wilson Arvanitakis, Cochise, AZ (US); Chrisanthos Arvanitakis, Cochise, AZ (US)

(73) Assignee: TegIPco, LLC, Dover, DE (US)

(21) Appl. No.: 19/541,714

(22) Filed: Feb. 17, 2026

Related U.S. Application Data
(60) Provisional application No. 63/759,499, filed on Feb. 17, 2025.

(51) Int. Cl. C25B 1/27; C25B 15/031; G01N 27/416; H01M 10/08

(52) U.S. Cl. CPC C25B 1/27; C25B 15/031; G01N 27/4167; H01M 10/08

(57) ABSTRACT

A Proton Rich Ionic Fluid (PRIF) is used as a carrying fluid and stabilizer for multiple common elements such as Carbon, Silicon, Sodium, Vanadium, Nitrogen, Sulfur and other common alkyl metals. These common elements will be carried inside common materials such as urea (CO(NH2), silicon dioxide, coal, graphite, glass and common salts such as sodium chloride, lithium hydroxide, and others. Each of the materials can be dissolved in the PRIF. Further, the solubility of these materials will help prove the stability and density of free protons obtained from the PRIF.

### BACKGROUND OF THE INVENTION

Urea (CO(NH2)) is in huge demand in the agriculture industry, but can be difficult to work with. Meanwhile, a Proton Rich Ionic Fluid (PRIF) can be helpful as a carrying fluid and stabilizer for multiple common elements, of which just one is urea. Consequently, a system and method for improving processing of urea and other common elements is desired.

### SUMMARY

The embodiments herein illustrate a Proton Rich Ionic Fluid (PRIF) used as a carrying fluid and stabilizer for multiple common elements such as Carbon, Silicon, Sodium (common alkyl metals), Vanadium, Nitrogen, Sulfur and others. This listing is for illustration only and should not be considered as limiting. These common elements will be carried inside common materials such as urea (CO(NH2), silicon dioxide, coal, graphite, glass and common salts such as sodium chloride, lithium hydroxide, and others listed in this patent.

The embodiments herein not only illustrate the usages of each of the materials dissolved in the PRIF but also use how the solubility of these materials will help prove the stability and density of the PRIFs free protons H₁⁺ which are inside the PRIF. Not only physical attributes will be shown but also electro-chemical stimulations that provide clear usages in urea, silica, and battery and energy storage fields that prove not only the utility of the PRIF 140, but also its novelty.

Within this disclosure, the expression “free proton” will mean H₁⁺ which is a single free hydrogen proton with no electron attached to its orbit. Also, the term pH will represent its true meaning which is “potential hydrogen” or “free hydrons”. Each of those terms must be set clear to avoid any misunderstanding in this disclosure.

One of the attributes of the fluid is a PH between 0-1 this is a result of the free H₁⁺ protons and the PRIF is neither an acid nor a dissolved hydronium ion. This must be made clear to ensure that the patent is properly referenced and recognized as a fluid that carries free protons at room temperature and with normal pressure. Also, this patent will reference terms and process such as the “Zeeman effect” and the “Dember effect”, as these terms are both used in physics and electrochemical observations.

The embodiments herein will also show that the PRIF is manufactured as electron deficient fluid suitable for enhancing chemical reactions and electro chemical analysis. In the chemical reactions shown herein, a solvation complex (solvation shell) is formed which will have an extensive non-covalent interaction such as hydrogen bonds, which then forms a protic-like dissolved H₁⁺ protonic fluid or a PRIF. This will be validated both electrochemically and through simple standard PH measurements.

### BRIEF DESCRIPTION OF THE DRAWINGS

Advantages of the embodiments will be apparent from the following detailed description of the exemplary embodiments thereof, which description should be considered in conjunction with the accompanying drawings in which like numerals indicate like elements, in which the figures provide additional embodiments and images related to the content described herein.

FIGS. 1A and 1B show non-limiting arrangements of reactor systems for producing a Proton-Rich Ionic Fluid (PRIF) according to the embodiments herein;

FIGS. 2, 3A, and 3B show example methods of operation of the reactor systems of FIGS. 1A and 1B;

FIGS. 4A, 4B, 4C, 5A, 5B, 5C, 5D, 6A, 6B, and 6C show detail of one or more recirculators;

FIG. 6D shows a specific configuration of recirculators and magnets;

FIGS. 7A-7B-7C show contrasting arrangements of alternate embodiments of reactor systems;

FIG. 7D shows a recirculator using information from a testing module;

FIGS. 8A-8D show results (sweeps) of Linear Sweep Voltammetry (LSV);

FIGS. 9A-9B show linear sweep voltammograms;

FIGS. 10A-10C show a customized electrochemical flow cell used in an EIS process

FIG. 11A-11B are Nyquist plots obtained through Electrochemical Impedance Spectroscopy (EIS);

FIG. 12 shows a way of mixing PRIF and urea;

FIGS. 13A-13B show that the PRIF/urea combination is more electrochemically stable at more negative potentials;

FIG. 14 show results from using PRIF in-solution in a mining process;

FIG. 15 illustrates a Zeeman effect on an unknown molecule being subjected to a magnetic field;

FIG. 16 shows an analysis of the PRIF being converted into a gas;

FIG. 17A-17B show aspects of enthalpy of vaporization;

FIGS. 18-20 show PRIF test-results such as Nitrogen % and pH.

### DETAILED DESCRIPTION OF THE PREFERRED EMBODIMENTS

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. As used herein, the word “exemplary” means “serving as an example, instance or illustration.” The embodiments described herein are not limiting but rather are exemplary only. It should be understood that the embodiments described are not necessarily preferred or advantageous over other embodiments. Moreover, the terms “embodiments of the invention”, “embodiments” or “invention” do not require that all embodiments of the invention include the discussed feature, advantage or mode of operation.

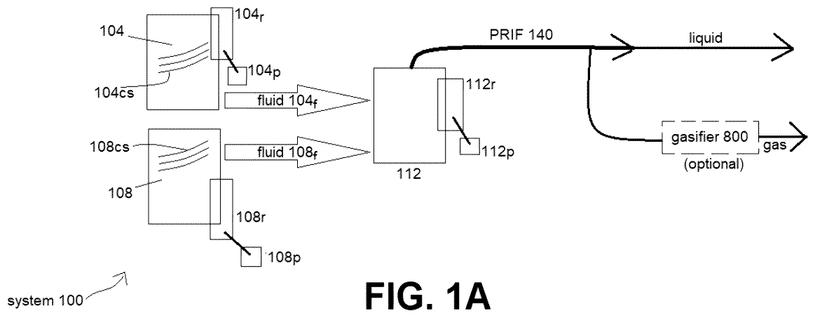

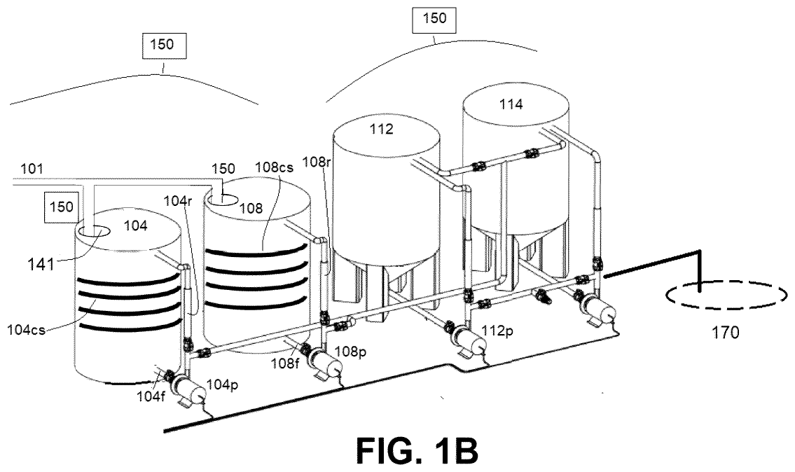

FIG. 1A shows an example system 100 for producing a proton-rich PRIF 140. The system 100 converts a common hydrogen-based input fluid 101 into the PRIF 140 which comprises an overabundance of hydrogen H₁⁺ atoms, mainly just protons since atomic hydrogen does not have a neutron and the electron has been peeled off. This conversion occurs in the absence of elevated temperatures or pressures, so that the resulting PRIF 140 is suitable for shipping or storage at Standard Temperature and Pressure (STP, AKA Normal Temperature and Pressure NTP). One example period of reliable shelf-life of the PRIF 140 might be 36 months, although there could be examples of even longer shelf-life, depending on the specific formulation.

The input fluid 101 may be one of various commonly found hydrogen-donating fluids or mixes of multiple hydrogen-donating fluids, and can also be dirty water, fracked water, and/or processed water. A non-limiting list of potential types of hydrogen-donating fluids can be found in an Appendix A to this disclosure, titled “EXAMPLE HYDROGEN-DONATING INPUT FLUIDS 101”.

Referring to FIGS. 1A and 1B, an example system 100 and flowchart includes a first tank 104, a second tank 108, a third tank 112, and corresponding recirculators 104r, 108r, 112r. Both first and second tanks 104\108 comprise recirculator 104r\108r, pump 104p\108p, and windings or inductor coils 104cs\108cs. Both first and second tanks also pump out intermediate fluids 104f\108f that has been partially processed and is on its way to becoming the proton rich ionic fluid (PRIF) 140. FIG. 1B shows a fourth tank 114 which acts as a potential overflow tank, or storage tank, or other way of assisting in management of PRIF 140 during or after a production run thereof. In the flowcharts of FIGS. 1A-1B, all activity flows from left to right.

The tanks 104\108 have the circumferential windings 104cs\108cs applied to their outer surface thereby forming a reaction zone. The windings 104cs\108cs can be formed with stranded wire or other types of windings to act as a large-scale inductor coil. FIG. 1B also shows a seal 141 on the tank, and a detector 150. The tanks 104/108/112 can be operated at NTP/STP, but for detecting various gaseous components, the seal 141 could be helpful in trapping and capturing. The detector 150 can capture a lot of different components, as will be discussed in more detail herein.

The circumferential windings or inductor coils 104cs\108cs may be electrically coupled to a power supply so as to be electrically coupled to either alternating or direct current at a variety of frequencies. An amount of insulation on the wires and tanks, a spacing between specific windings, and wire gauge all may vary according to a desired outcome.

The pumps 104p\108p are coupled to the recirculators 104r\108r which have magnetic modules 508 in various orientations attached thereto. However, the magnetic modules 508 can come in a lot of widely differing formats, of which the embodiments shown in the various FIGS herein are but non-limiting examples.

The activity within the reactor system(s) 100 result in removing electrons from the input fluid 101 in such a way that the resulting PRIF becomes electron-deficient. This PRIF 140 can remain electron deficient at STP for varying periods, e.g. having a shelf-life of 36 months.

The circumferential windings 104cs\108cs can have a variety of voltages and currents applied thereto. The voltage applied to the windings 104cs may be equal to that applied to the windings 108cs, or may not. Further, a voltage may be applied to one set of windings but not the other, and polarity may be altered.

A pre-determined wattage for the circumferential windings 104cs\108cs can be selected based on the chemical constituents of the input fluid 101, a desired configuration of the PRIF 140, ambient temperature, volume of end-product, and other factors. As current moves through windings 104cs\108cs, a corresponding magnetic field directed perpendicularly to windings 104cs\108cs applies a magnetostatic force to liquid 101 while being circulated through the tanks 104\108 for a predetermined period of time until the outlet fluid 104f\108f is transferred via e.g. to the 3^{rd} tank 112.

The magnetostatic forces applied to the windings 104cs\108cs can be adjusted between 2,000-80,000 Gauss, with 20,000-80,000 Gauss being a preferred range. When outlet openings 104f and 108f are opened, the fluids 104f\108f are combined into the third tank 112 which comprises a recirculator 112r and pump 112p. Once the fluid from both first tank 104 and second tank 108 are combined into the third tank 112, the combination is pumped and recirculated within the third tank 112.

Unlike the first tank 104 or second tank 108, third tank 112 does not have a circumferential windings, and therefore experiences no electrostatic effects. Instead, the third tank 112 experiences an oscillating magnetic field through the recirculator 112r due to the magnetic-modules 508 attached thereto. An embodiment exists in which the third tanks is not used at all, where the main finishing of the PRIF-formation process occurs in the second tank 108.

During operation of the system 100, some oxygen vapes off, and goes away in a variety of forms. This is due to the fact that one purpose of the system 100 is to break the covalent bonds of a water molecule, separate out the oxygen\electrons and drive them off (prevent them from re-combining), and thus isolate protons in the form of H₁⁺. One reason this can be done at low power is because a typical water molecule is known to be a weak dipole, where some of the H can be separated from the O just by mechanical forces, some of which occur within the recirculators 104r/108r/112r.

The sensors 150 are used to affirm proper performance of the system 100, including temperature. In tank 104 there may be a slight exotherm 20-30 degrees F. based on which proton donor was used within the input fluid 101. Content of the specific chosen input fluid 101 can affect this, due to clean water v. dirty water v. produced water or other type of effluent source (see Appendix A).

Oxygen may gas off maybe 2-3% in overall mass difference, perhaps in the format of 02 but also in other formats. Various oxygen radicals are formed during production-use of the system 100, mostly oxygen based salts, which can vary according to a wide variety of conditions including but not limited to the content of the input fluid 101. These salts end up getting excreted through the back-end portion 170 of the system 100.

In a lower-cost embodiment, the detector 150 can be focused mainly on CO2 and O2, which both have special significance in hydrogen generation. However, the detector 150 can have wider scope, depending on manufacturing considerations and end-customer preferences.

If the input fluid 101 contains sulfuric acid, that can lead to sulfate salts, colloidal sulfur, and/or sulfur dioxide. Meanwhile, produced water tends to result in carbonates, oxides, and chloride salts. Acetic acid can lead to acetate salts.

The semicircle 170 represents a combination of filters, precipitate catch mechanisms, and or hydrocyclone, which may catch any of the below. That is, a non-limiting list of specific oxygen radicals and salts (either gas or solid) given off during use of the system 100 can include but are not limited to:
hydroxide salts (_OH); carbonate salts (_CO3);
sulfate salts (_SO4); nitric salts (_NO3);
dioxides (_O2), the most of important of which is CO2;
acetates (_CH3COO—); and alkoxides (_COH alcohol salts).

The proton-donating input fluid 101 (Appendix A) can comprise many different blends and even different waters and oils thus any of these will have different sludges and precipitates.

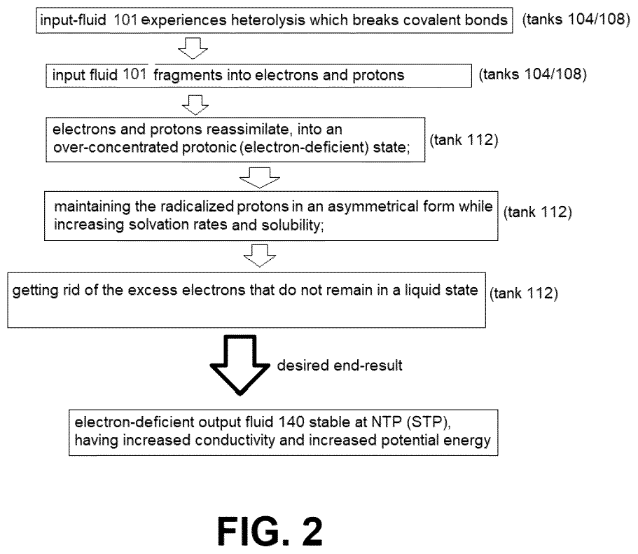

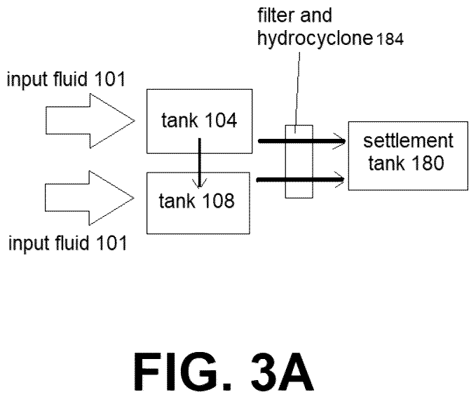

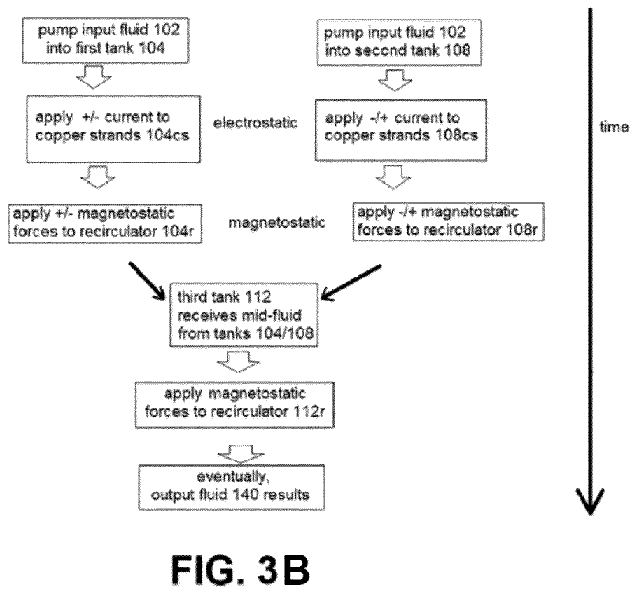

FIGS. 2 and 3A-3B show example methods of operation of the reactor systems of FIGS. 1A and 1B. Regarding the flowchart of FIG. 3A, in an embodiment, the second tank 108 might have twice the capacity of the first tank 104. An example operation of the flowchart of FIG. 3A might be where the tanks 104/108 are filled up with the input fluid 101 in equal proportions, and processed separately. The recirculators 104r/108r (not shown in FIG. 3A) could be set to opposite polarities or to alternating and non-alternating polarities. Then, the contents of tank 104 could be put into second tank 108 for further processing for predetermined time periods.

The second tank 108 might have the following elements added which may not be in the first tank 104: flocculants, polyacrylamides, ferric sulfates, and/or gypsum. An additional variation might be to add alcohol to the input of the first tank 104.

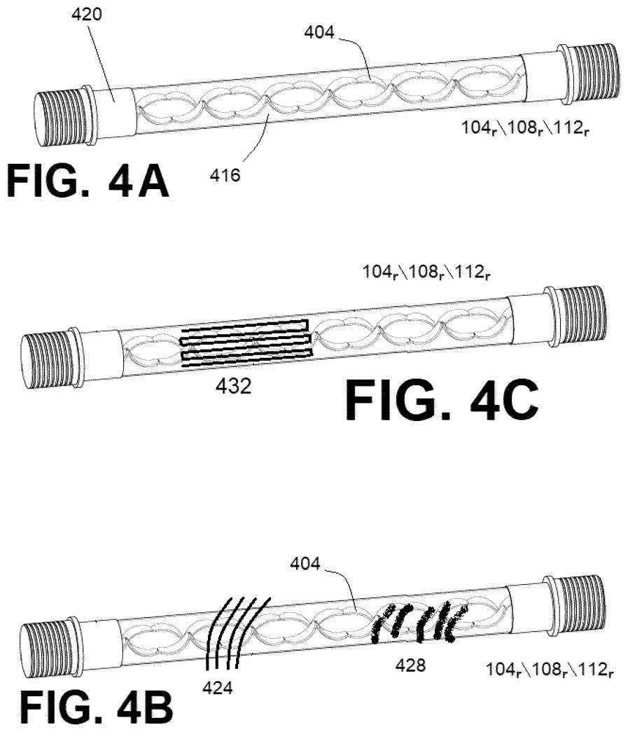

FIGS. 4A, 4B, 4C, 5A, 5B, 5C, 5D, 6A, 6B, and 6C show detail of the recirculators 104r, 108r, and 112r, which (combined with the pumps and magnets) are sometimes referred to as static mixers. As shown at least within FIGS. 4A-4C, each recirculator can be formed as an elongated translucent tube that has movable internal fluting 404 (AKA baffle) located therein. The recirculators 104r, 108r, and 112r further comprise a grommet 420 at each end, along with threaded surfaces so that they may be connected in series. The internal fluting 404 aids in restraining fluid flowing through the tubes 416 thereby forming a type of reaction zone in which covalent bonds can be broken, and heterolysis can occur (FIG. 2).

Each internal fluting 404 can be formed with a plurality of grommets 420 that can be concatenated to one another so as to form a chain structure if desired. The fluting 404 is important because it can break or at least strain the covalent bonds holding water together. It is an advantage of the embodiments herein to break the covalent bonds of the water with as little energy as possible. The fluting 404 leverages the fact that water molecule has a strong dipole, thus a weak covalent bond.

FIG. 4B shows example windings 424 and inductor coils 428 embedded within the plexiglass body (tube 416) of a recirculator. These coils 428 are configurable at a variety of polarities and electromagnetic capabilities. FIG. 4C shows another example of inductor-patterning, where an inductive mechanism 432 is configured in a “rear window defogger” serpentine configuration.

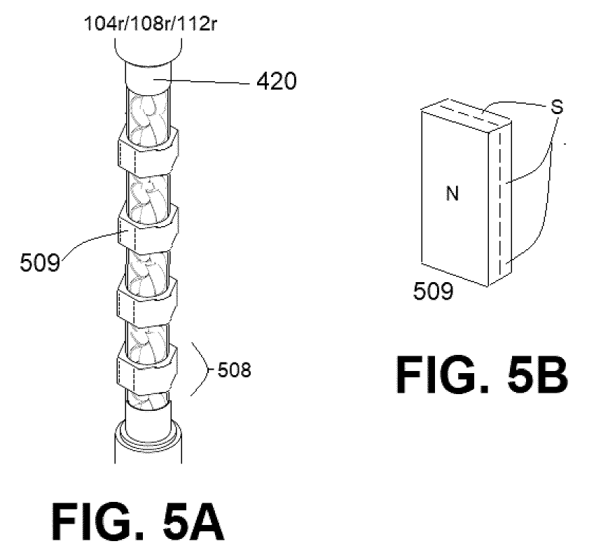

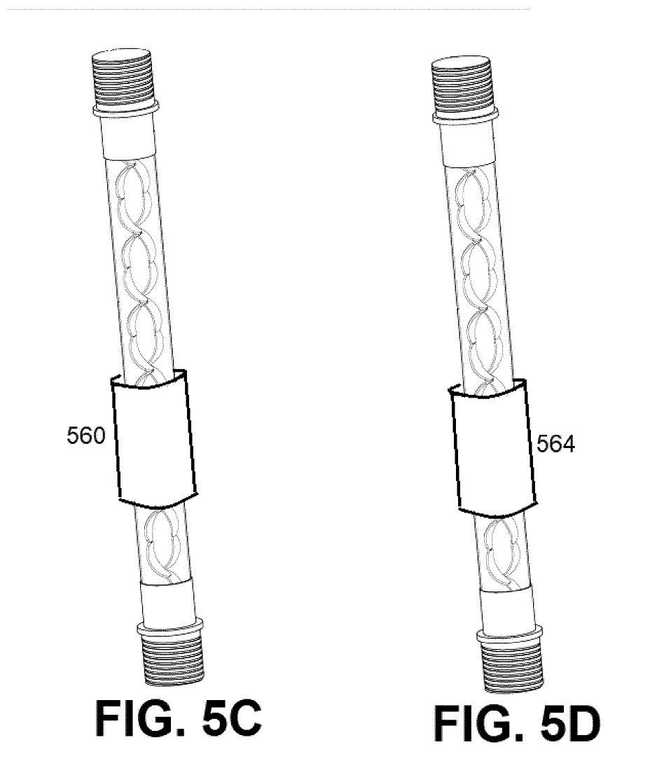

FIG. 5A shows an example recirculator with magnets 509 taped on. FIG. 5B shows an example of rectangular magnet 509 that is polarized in a way different than a domino magnet. FIG. 5C shows a recirculator with a slidable adjustable mechanical magnet-cuff 460. FIG. 5D shows a recirculator with a slidable adjustable electrical inductor-cuff 460.

The system 100 is designed to work in a variety of locations and climates, and with widely varying quality of water including unknown salinity, unknown metal content, unknown viscosity, and unknown level of pollutants. Accordingly, the magnetic modules 508 would be tunable and subject to continual adjustment. The system 100 may be used in remote areas where spare parts may be inaccessible, and may receive what small amounts of power it needs, from solar devices or off-grid devices that have varying levels of reliability. The magnetic modules 508 will have a lot of flexibility and adjustability, both mechanically and also electronically.

Moving to FIG. 5A, within any particular recirculator, the plurality of magnetic modules 508 are arranged circumferentially about the outer surface of the tube 416 and periodically located its length. In some embodiments, a magnet pack 508 is formed with one or more static bar-magnets 509 that define opposite polarities often denoted as a North and South.

The magnetic modules 508 are arranged on an outer surface of the tube 416 in specific ways. One example arrangement is where each North pole side may be facing e.g. radially inwardly, toward the center of tube 416. In this arrangement, each South pole side of a magnet or magnet group 509 would then face radially outwardly from an outer surface of the tube 416. The specific size, shape, and orientation of the individual magnets 509 can vary. FIG. 5B shows an example magnet 509 having a non-domino shape, but that is for example only.

As shown in FIG. 2, in operation, input fluid 101 is piped into tanks 104\108 until at least partially filled. The tanks 104\108 will have a predetermined wattages applied through their respective windings 104cs\108cs for predetermined time periods, often at least 45 minutes. Often, current applied through the circumferential windings 104cs\108cs may be between 5-100 amps at a wattage between 60-1200 watts, with 100 amps at 1,000 watts being advantageous. FIG. 3B shows another way of interpreting the flow within the system 100

During use, the recirculating pumps 104p\108p move the input fluid 101 through the tanks 104\108 via the recirculators 104r\108r. These in turn apply a uniform static magnetic field to input liquid 101 via the magnets 508.

A polarity applied to the recirculator 104r may be opposite the polarity applied recirculator 108r. In one embodiment, recirculator 104r will be set with North pole sides 193 facing radially inwardly applying a total of 46,000 Gauss to input liquid 101, while the recirculator 108r will be set with South pole sides facing radially inwardly thereby applying a total of 46,000-58,000 Gauss to the input liquid 101.

Continuing this example, constant recirculation of the input fluid 101 from the tanks 104\108 through recirculators 104r\108r causes a non-transitory polar imbalance in the input liquid 101 resulting from breaking the strong dipole known to be present in water. The differences in fluid velocities within recirculators 104r\108r thus creates a separation and segregation of atomic hydrogen H₁⁺ within the input fluid 101.

The reactor system(s) 100 can be operated with a variety of ranges and thus have a lot of configurability and ability to be customized for specific types of production runs of the PRIF 140, and also can be adapted to specific types of input fluid 101. As stated, typically, the input fluid 101 will be a hydrogen-donating fluid such as shown in Appendix A. Further, each of the first, second, and third recirculators 104r\108r\112r can separately apply a pre-configured magnetic field to the fluid circulating therein, therefore creating a separate proton-rich vortex within each of the plurality of tanks 104\108\112. These pre-configured magnetic fields can be adjusted applied by the recirculators can be auto-adjusting. Further, if the right levels of intermediate fluids 104f\108f are occurring, the magnetic fields can be shut off entirely.

The specific magnetic field applied may vary according to characteristics of the input fluid 101. A key factor is that heterolysis (FIG. 2) occurs and breaks the covalent bonds in the water-portions of the input fluid. Subjecting the input fluid 101 to a magnetic field provides a low-cost non-CO₂-creating way of doing this.

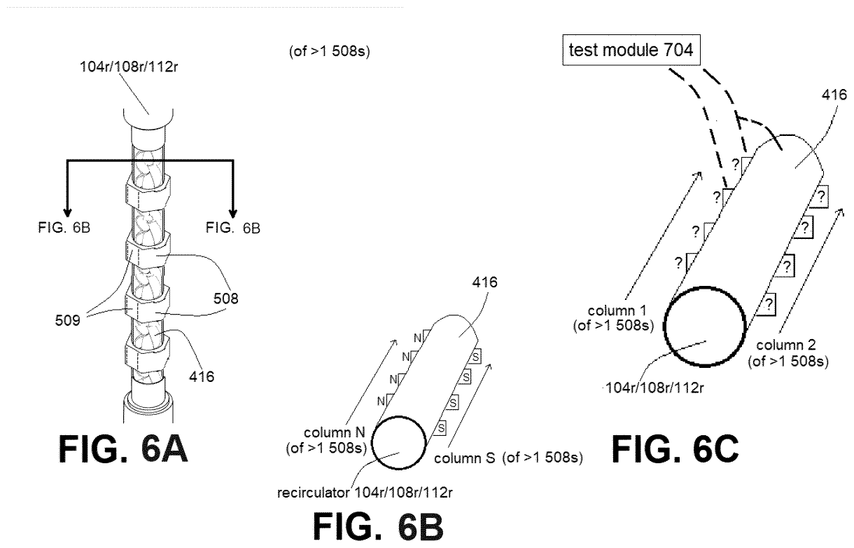

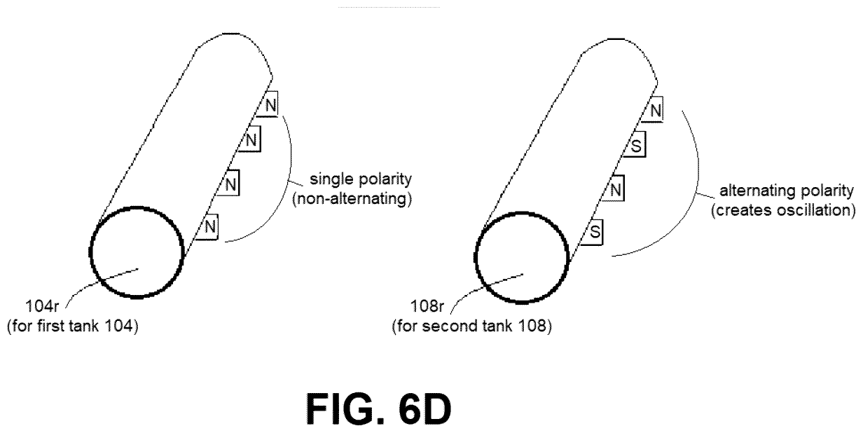

FIGS. 6A-6C show example recirculators 104r/108r/112r and FIG. 6C shows a testing module 704 that can affect production of the PRIF 140 in real-time. Under the right circumstances, the inductors of FIG. 6C can be re-oriented in a variety of patterns and polarities, hence the question-marks of FIG. 6C. The recirculator of FIG. 6C is patterned to look similar to FIG. 6B, which shows static magnets with known fixed polarities, but that is for illustration-only and the embodiments herein should not be considered as limited exclusively thereto. Instead, FIG. 6C should be interpreted to borrow from the example of FIG. 6B, but expand it to show a variety of configurations and adjustable features including not being committed to a specific polarity. The embodiment of FIG. 6C shows a test module 704 and columns of magnetic modules 508 that can be changed depending on feedback from the test module.

FIG. 6D shows an example arrangement of polarities of magnets attached to recirculators 104r and 108r. In the example on the left, the recirculator 104r attached to the first tank 104 has magnets attached in a uniform consistent\polarity arrangement. Meanwhile, the recirculator 108r attached to the second tank 108 has its magnets attached in an alternating polarity arrangement. As the fluid flows through this recirculator 108r, an oscillating effect occurs. Thus, the two recirculators 1048r, 108r have two different effects on the fluid circulating therethrough, so that their pH may differ widely e.g. the first tank 104 might have a pH of.

After some processing, it is possible to recombine the two fluids. This will be discussed in more detail with respect to acid-base reactions.

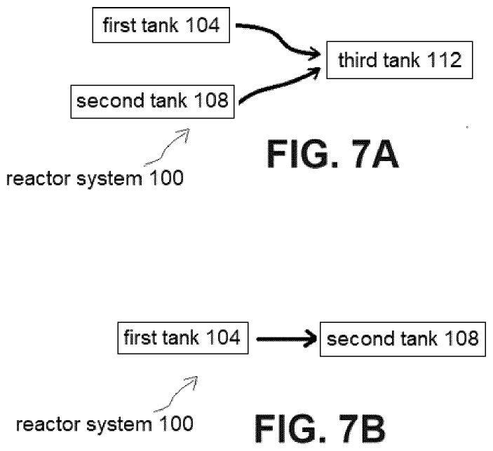

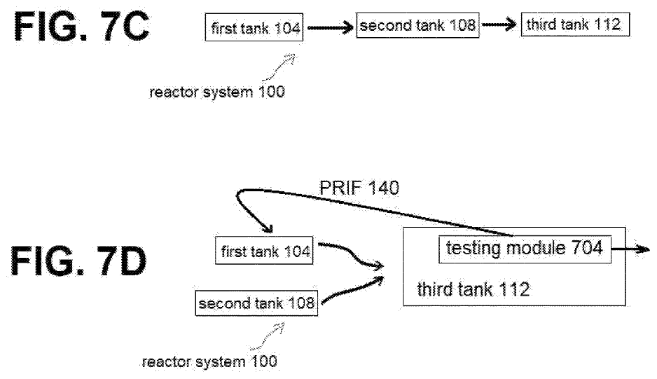

The testing module 704 of FIG. 6C and FIG. 7D can sense breaking of covalent bonds, other factors, and can adjust magnetic or electromagnetic fields and polarities in order to achieve a desired content of PRIF 140.

This concludes discussion of the reactor system 100 and the production of the PRIF 140. What follows are some usages and implementations incorporating the PRIF 140.

Usages of PRIF 140 with Common Elements Including Urea

An assortment of PRIF-urea, PRIF-commonElement, and PRIF-battery embodiments will now be discussed. One PRIF-battery embodiment grants an ability to store\move electrons through proton tunneling, specifically electron transfer proton tunneling, and also reduce Oxygen Evolution Reaction (OER). For various reasons that will be explained in more detail herein, the embodiments herein will strive to minimize or reduce OER.

A battery novelty based on mixture inside the electrolyte that is based within the PRIF that would be considered in a semi-solid or gel-like polymer state. Being in this state reduces dendrites within solid-state or gel/polymer batteries. Dendrites are root-like structure or crystal structures that form in batteries over time. These break down any positive and negative separators leading to a direct short in the battery. These dendrites also have direct correlation with OER, so that stopping OER can stop dendrites. These electrolytical formulations of mixtures of PRIF and common salts like lithium or sodium or vanadium salts will allow electrons to keep passing the barrier from anode to cathode but reduce dendrites from extending or even starting, due to limited or near-zero OER.

In a fluid or a semi fluid solid state battery when the base of the electrolytical solution is the PRIF 140, one doesn't have the issue of dendrites. The PRIF 140 thus has a usage within not only to the stated facts above but its ability to solubilize Vanadium, Sodium, Lithium, Silicon, and other standard energy storage electrochemical ingredients. To affirm this, the PRIF can be exposed to electrochemical testing through a process called Electrochemical Impedance Spectroscopy (EIS).

EIS is achieved using an instrument known as a potentiostat. A potentiostat measures features of various liquid during application of electrical current in various formats. Such a potentiostat utilizes a three-electrode system—Working Electrode (WE), Reference Electrode (RE), and Counter Electrode (CE)—to accurately control electrical potential and measure current in electrochemical cells. The WE is the sample/site of interest, the RE provides a stable reference potential, and the CE balances the current, allowing for precise control of the potential across the electrolyte, in this case PRIF and other components.

A potentiostat is helpful for measuring and affirming levels of both HER and OER. Within this disclosure, it will be understood that reductions in OER are preferred, and increases in HER are preferred, for various reasons which will be pointed out at an appropriate time.

The EIS findings herein show how electrochemical stimulation recombines hydrogen efficiently but the oxygen evolution is highly reduced, because of the concentration of H₁⁺ protons. Again, the formation of hydrogen is forced in the experiment to theoretically force an oxygen reaction co-action. By constantly pushing up a test voltage within the potentiostat 1020, it can be affirmed that a proportional oxygen evolution does not occur in the PRIF-based electrolytic solutions.

In viewing EIS images, bear in mind the various images produced by EIS are not graphs of a signal produced over time, e.g. an electrical signal or something like that, with a time-scale as the horizontal axis progressing from left to right as is conventional. Instead, EIS images should be viewed more like photographs or spectra. These images are sometimes referred to as “sweeps” except they are not sweeps over time, instead sweeping over some other non-temporal parameter e.g. potential (Voltage v. Ag/AgCl).

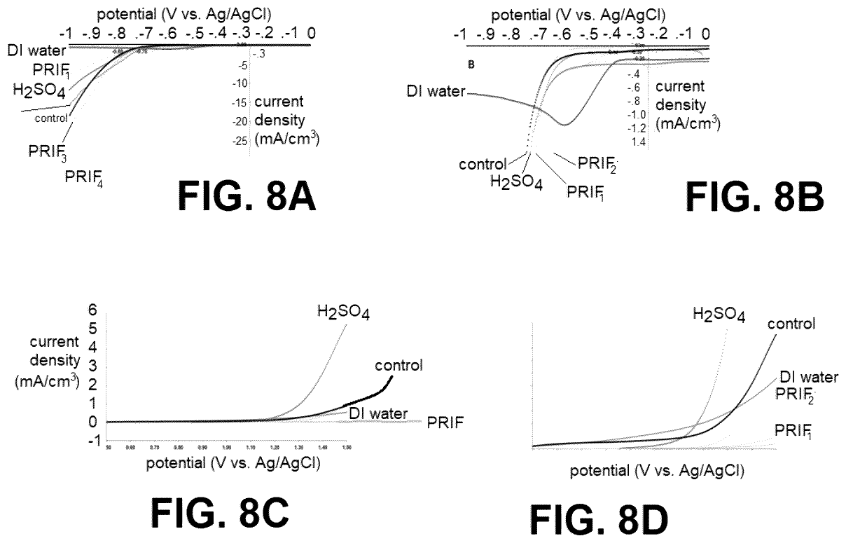

FIGS. 8A-8D show results of Linear Sweep Voltammetry (LSV). The sweep of FIG. 8A is set at 10 mV/s. FIG. 8B shows a Hydrogen Evolution Reaction (HER) from 0 to −1V (vs Ag/AgCl). FIGS. 8C-8D show Oxygen Evolution Reactions (OERs) from 0-1.5V (vs Ag/AgCl) of various samples of PRIF, along with H₂SO₄ and DI water. To ensure no acid or hydronium profiles are found in the various combinations, a test-voltage is pushed well beyond 1.2-1.5 volts, as shown in FIGS. 8A-8D. Doing this extra step helps show the embodiments herein are focused on H₁⁺ protons and not an acidic or hydronium (H₃O⁺) based electrolyte.

FIGS. 8A-8D show other testing using standard electrochemical materials such as sulfuric acid or water based aqueous solutions with dissolved salt. These are included for showing the key differences in contrasting the final PRIF based solutions with H₂SO₄ and DI water. These differences also illustrate how the PRIF could be superior as a battery electrolyte in a common battery environment as well as specialty batteries such as flow batteries and solid state & semi solid-state batteries.

The PRIF does not contain any hydronium or acid water derivatives because it has been pushed through electrochemical analysis well past 1.5 volts with no apparent OER. This affirms that hydroniums (H3O⁺) were not created.

### Key Results

FIGS. 8A-8D show a Hydrogen Evolution Reaction (HER) EIS sweeps implemented using a glassy carbon electrode within the potentiostat 1020. A magnetic field process in the PRIF impacts the kinetics for hydrogen catalysis, so that a reduction of H₁⁺ to H₂ process starts at a less negative potential.

The PRIF 140 has a higher (or more positive) onset potential at −0.251 V (vs. Ag/AgCl), which indicates of a lower potential required for producing hydrogen. As expected, being a strong electrolyte, 1 M H₂SO₄, the dissociation of H₂SO₄ leads to the H₃O⁺ (hydronium) and subsequent reduction to H₂ gas evolution starting at a more positive on set potential throughout the voltage sweep from 0 V to −1.5 V (vs Ag/AgCl). This is not observed in the PRIF portions of the sweeps of FIGS. 8A-8D. The PRIF 140 achieves a higher current density within the potential window indicating a larger reduction current from the reduction of H₁⁺.

FIGS. 8A-8D also show EIS sweeps for DI water, which exhibits a positive on-set potential but with a sharp increase in current density for H₃O⁺ (hydronium) reduction due to autoionization, which is unique to water-only and not PRIF. This in turn shows key differences in the properties of ordinary water v. the PRIF 140. Reproducibility in production process of the PRIF 140 demonstrated by consistency across many sample batches thereby also affirms reliability of Applicant's methods of manufacturing disclosed herein.

FIGS. 8C-8D show an Oxygen Evolution Reaction (OER) performance with glassy carbon electrode. Current density profile is relatively constant, sweeping positive from 0-1.1V V (vs Ag/AgCl). A current density of the PRIF 140 is consistently and dramatically lower than water, almost to a near zero production. Reduced OER and reduced current density is a good attribute of the PRIF 140, beneficial, which will be explained in more detail herein.

A breakdown occurs >+1.2 V (vs Ag/AgCl) as shown, with the large increase in current density at higher potentials. This proves PRIF is not acidic or any H₃O⁺ is present in any formulation of the PRIF. The electro-chemical stimulation of the PRIF 140 shows that hydrogen is a recombination of the H₁⁺ and does not produce directly proportional oxygen evolution, and this was forced in the testing parameter to prove the stability of PRIF neat and when used with dissolved common salts as a stable and more superior electrolyte base solution.

It is important to note that unlike the other fluids in FIGS. 8A-8D, a significant amount of energy applied does not build up within PRIF and eventually produce unwanted oxygen (OER). In fact, with the PRIF 140, little energy is “lost” in the oxygen side of the reaction. Therefore, less “round-trip” power is needed to get the same amount of H₂ from PRIF and store energy from other typically used electrolytes.

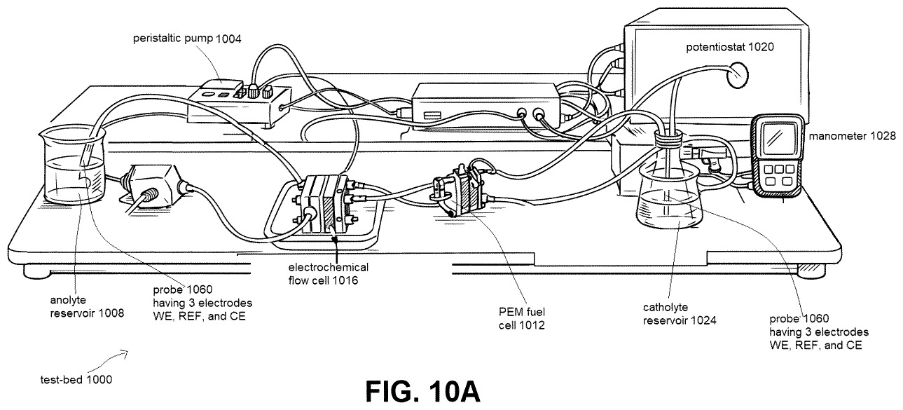

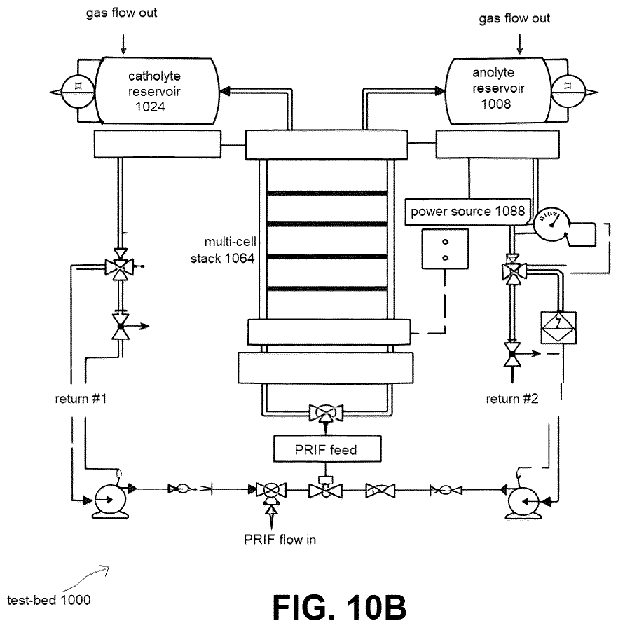

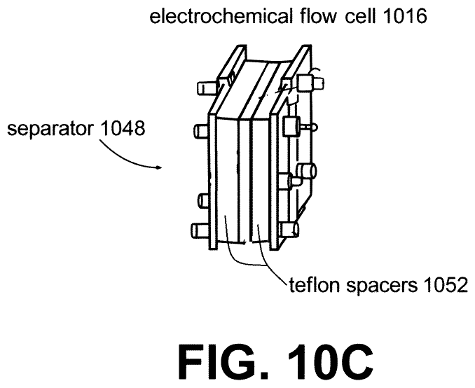

A customized electrochemical test bed 1000 is used in the EIS process, as shown in FIGS. 10A-10B. One purpose of these flow cell arrangement(s) is to make gas from various liquids being tested (e.g. 1M Sulfuric acid (H₂SO₄), 18M, PRIF, and DI H20). In the test bed 1000, the electrodes are the plurality of plates in the electrochemical flow cell 1016. These are sometimes made from glassy carbon, sometimes graphite, sometimes platinum.

In FIGS. 10A-10B, the flow transmitter (FT) measures the gas flow rate. The composition transmitter (CT) measures what type of gas is being generated, and purity of each gas. The manometer 1028 measures the pressure acting on a column of fluid. The gas is always combined from both sides of the separator 1048 to make a single gas flow, hence “flow channel”. The example test-bed 1000 as shown in FIGS. 10A-10B identifies the same test-bed 1000 but where not all elements are shown in each Figure.

This test-bed 1000 includes an electrochemical flow cell 1016, a Proton Exchange Membrane (PEM) fuel cell 1012, anolyte and catholyte reservoirs 1008, 1024 respectively. The reservoirs have 3-electrode probes 1060 inserted therein. A peristaltic pump 1004 provides force to the electrochemical flow cell 1016.

The potentiostat 1020 performs tests (including Linear Sweep Voltammetry) using a 3 electrode probe 1060 having e.g. glassy carbon as a working electrode (WE), an Ag/AgCl reference electrode (REF), and a platinum wire counter electrode (CE) with sweeping voltage from 0-1.5V to characterize the Oxygen Evolution Reaction (OER) catalysis for 18M sulfuric acid, 1M sulfuric acid, DI water, and PRIF electrolytes. Within this disclosure, it will be understood that reductions in OER are preferred, and increases in HER are preferred, for various reasons which will be pointed out at an appropriate time.

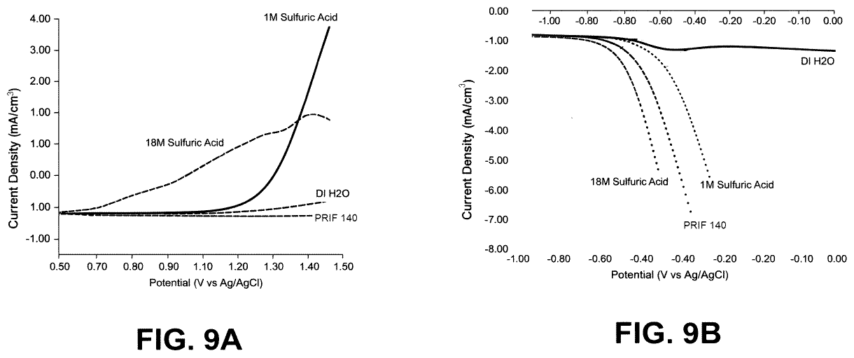

Now moving to how the test bed 1000 is used, and the results (e.g. “sweeps”) it obtains, the reader will note that the positive voltage region of the sweep of FIG. 9A of indicates the lower near zero OER profile in PRIF compared to 18M Sulfuric Acid, 1M Sulfuric Acid, and DI water. A key difference between PRIF based electrolytes and the other electrolytes shown is a slow increase in current density sweeping positive voltage (to the right). FIG. 9B shows an evolution of hydrogen, where the PRIF 140 is observed to produce H₂ in between 1M and 18M sulfuric acid concentrations. Thus, FIG. 9B demonstrates how PRIF evolves oxygen very differently and near zero compared to acid-based and/or common electrolytes.

FIGS. 9A and 9B show linear sweep voltammograms performed at 10 mV/s. FIG. 9A demonstrates amounts of Oxygen Evolution Reaction (OER) occurring from 0-1.5 V vs Ag/AgCl. FIG. 9B demonstrates amounts of Hydrogen Evolution Reaction (HER) occurring from 0 to −1.0 V (vs Ag/Ag/Cl) of the PRIF 140, compared to 1M H₂SO₄, 18M H₂SO₄, and DI Water.

Summarizing FIGS. 9A-9B, overall the PRIF 140 exhibited the smoothest reduction in current density profile from 0 V to ~0.85 V (vs Ag/AgCl) where there was larger catalytic activity from the reduction of H₁⁺ that is present in the PRIF to form H₂ gas. Within the potential window, the reduction current PRIF 140 produced was greater than that of 1M H₂SO₄ and did not exhibit a breakpoint indicating the stability beyond 1.2-1.5 V.

Further, PRIF's maximum current density ~200 mA/cm² was 1.5× greater than 1M H₂SO₄. The PRIF 140 exhibited only 1.5× less steady state current density at −1 V (vs Ag/AgCl) compared to concentrated 18 M H₂SO₄. The PRIF 140 also showed a steady reduction current increase until −0.35 V (vs Ag/AgCl) compared to H₂SO₄.

FIG. 9B shows that concentrated 18M H₂SO₄ and more diluted 1M H₂SO₄ have lower onset potential due to their high concentration of H₃O⁺ (hydronium). Meanwhile, FIG. 9B affirms that the PRIF 140 does not contain any hydronium, an important factor because hydroniums suggest OER which is unwanted. In FIG. 9B an important factor in understanding the PRIF 140 is the distance of the PRIF extends from the vertical-axis in the center of the Figure. Also note that the DI water graph has almost no curve whatsoever.

Next, within the a test-bed 1000, the separator 1048 has a crystalline platinum surface, and the following was observed. PRIF increased oxidation current density on the crystalline platinum surface throughout the +1.5 V potential window due to oxidation of H₁⁺ in solution. Through 1000 cycles, PRIF OER current density similar to H₂SO₄ up to +1.1 V (vs Ag/AgCl) but PRIF is the only one that can go higher than 1.5 Volts. PRIF's OER current density profile >1.1 V (vs Ag/AgCl) is more constant than H₂SO₄ with low current density changes with cycling.

One of the key advantages that PRIF 140 has over known commercial fluids is its higher conductivity. This allows more power to go directly to hydrogen production, and less loss to the environment—sometimes known as “overpotential” although the actual definition of overpotential is more complex than that. The Electrochemical Impedance Spectroscopy (EIS) described herein is used to characterize the impedance performance from 1 MHz to 1 mHz in the custom electrochemical flow cell 1000 (see e.g. FIGS. 5A-5C) with a hydrogel coated separator 1048 dividing flat plate impervious graphite electrodes to serve as the cathode and anode.

In FIGS. 10A and 10C the separator 1048 is drawn down the middle, with the flow-channels located on either side. The test bed 1000 in FIG. 10A shows a single flow cell 1016. The flow-arrangement in FIG. 10B is similar, but has multiple flow cells in a multi-cell stack arrangement 1064. The potentiostat 1020 is not shown is not shown in FIG. 10A. FIG. 10C shows teflon spacers 1052 positioned on either side of the separator 1048 to maintain the flow channel's thickness and length. The electronic and ionic conductivity, mass transfer properties, and insight into electrolyte performance within stationary and flowing conditions were probed using EIS. Specifically, mass transfer resistance is the opposition to a substance's movement across or within phases, acting as a critical, often rate-controlling factor in chemical engineering, separation processes, and adsorption.

The potentiostat 1020 utilizes the three-electrode probes 1060 comprising a Working Electrode (WE), Reference Electrode (RE), and Counter Electrode (CE) to accurately control electrical potential and measure current in electrochemical cells. FIG. 10B also shows a power source 1088.

FIG. 10B shows how the custom electrochemical flow cell 1000 affirms high amounts (e.g. 99%) of pure hydrogen in the PRIF 140. There is a need to affirm the hydrogen-content of PRIF is high, but accurate test-mechanisms have proven to be a challenge. This need is what gave rise to the test bed 1000 using a flow cell 1016 (FIG. 10A-10B) which provides affirmation\enablement partly through a gasification process. Such a gasification setup also works as a materials-testing device for various electrode-composition. It may be important to determine whether carbon works as well as platinum, titanium, and whether any are as effective as e.g. nickel coated carbide. The test bed 1000 can be helpful for this.

The embodiments of FIGS. 10A-10B have another usage, related to ammonia (NH3). It is possible to put an iron catalytic shield in the middle of the flow cell, force nitrogen and air through it, could convert the flow cell into an electrochemical ammonia project.

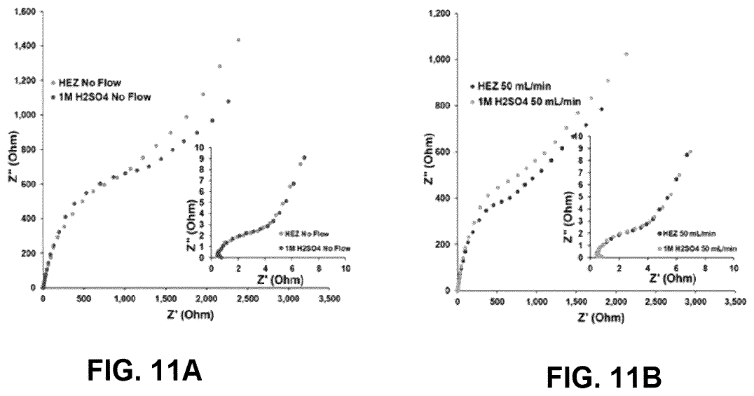

FIG. 11A-11B are Nyquist plots obtained through Electrochemical Impedance Spectroscopy (EIS) sweeping from 1 MHz to 1 mHz comparing FIG. 11A—PRIF 140 and 1M H₂SO₄ without flow (0 mL/min) and FIG. 11B—PRIF 140 and 1 M H₂SO₄ flowing at 50 mL/min through the custom test bed 1000 and flow cell 1016.

FIGS. 11A-11B (Nyquist) and the data in Table 1 (below) both demonstrate: (1) that the electronic conductivity is one order of magnitude higher in PRIF due to lower mass transfer resistance evaluated with DC limit experiments, (2) higher ionic conductivity is due to the ionic strength with capacitance of PRIF, (3) in stationary conditions with no flow, PRIF has higher capacitance and (4) at higher flow rates, PRIF's mass transfer resistance is lower, as also shown in FIG. 9B.

TABLE 1
Undivided Cell (No Separator)

| | | | Ionic | | DC Limit | Electronic |
|---|---|---|---|---|---|---|
| | Flow Rate | High Frequency | Conductivity | DC Limit | Resistance | Conductivity |
| Electrolyte | (mL/min) | Resistant (Ω) | (S/cm) | Current (A) | (Ω) | (S/cm) |
| HEZ | 0 (No Flow) | 0.735 | 3.434 | 2.16E−05 | 4.63E+03 | 5.45E−04 |
| | 10 | 0.694 | 3.636 | 3.65E−05 | 2.74E+03 | 9.21E−04 |
| | 30 | 0.720 | 3.505 | 4.54E−05 | 2.20E+03 | 1.15E−03 |
| | 40 | 0.657 | 3.841 | 5.27E−05 | 1.90E+03 | 1.33E−03 |
| | 50 | 0.726 | 3.476 | 6.41E−05 | 1.56E+03 | 1.62E−03 |
| 1M H₂SO₄ | 0 (No Flow) | 0.737 | 3.424 | 1.89E−05 | 5.29E+03 | 4.77E−04 |
| | 10 | 0.767 | 3.290 | 3.26E−05 | 3.07E+03 | 8.23E−04 |
| | 30 | 0.694 | 3.636 | 3.13E−05 | 3.19E+03 | 7.90E−04 |
| | 40 | 0.678 | 3.722 | 3.16E−05 | 3.16E+03 | 7.97E−04 |
| | 50 | 0.798 | 3.163 | 2.54E−05 | 3.94E+03 | 6.41E−04 |

Table 1 shows properties of PRIF vs 1M H₂SO₄ obtained using the various EIS sweeps described herein performed at 0V using a Standard Hydrogen Electrode (SHE) as a theoretical minimum. By determining the voltages at various overpotentials for HER and OER an overall combined overpotential (n measured in Volts) is obtained. Within this specification, the Greek letter n will symbolize “activation overpotential” or just “overpotential”. With an increase in conductivity and reduced resistance, an expected decrease in activation overpotential for PRIF compared to conventional technologies occurred, as was expected.

Within the embodiments herein, sometimes overpotential is unwanted, and other times overpotential is good. Overpotential is a complex topic. To avoid distraction, the discussion of overpotential will be limited to some specific contexts.

The electrochemical overpotentials for HER and OER was assessed in the divided electrochemical flow cell 1016 of FIGS. 10A-10C (divided by the separator 1048) using varying flow rates. As a performance measure, constant current density at ±0.4 mA/cm² was chosen to evaluate the voltages from HER and OER experiments. The overpotential n (Volts) for HER was determined from the difference from the theoretical minimum for the standard reduction potential of Hydrogen at 0.00 V as a reference for the standard hydrogen electrode. The overpotential for OER (η_OER in Volts) was determined from the difference of +1.23 V (vs SHE) as the theoretical minimum.

By determining the voltages at these overpotentials for HER and OER, the overall combined overpotentials can be used to determine the power needed for a test cell for gasification. Importantly, the power can scale based on the number of flow cells in series or parallel to obtain the voltage requirements needed for meeting specifications for gasification. The increased flow rate removed gaseous products (H₂ and O₂) from the surface of the electrode more efficiently. The high mass transfer rate was achieved at increased flow rates to minimize the buildup of gaseous products during the reduction and oxidation processes resulting in lower energy losses (overpotentials) and increased reaction efficiency.

### PRIF\Urea Combination as Electrolyte, Fertilizer, and in Ammonia Synthesis

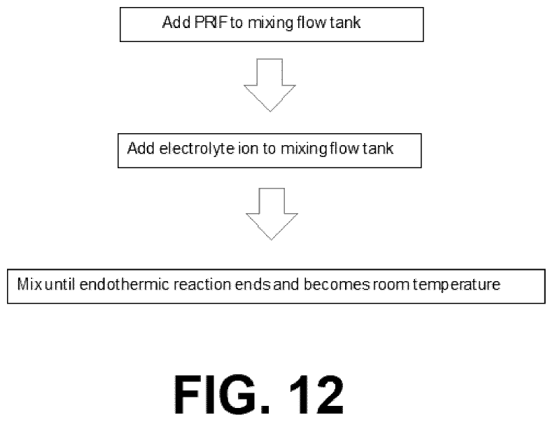

The following discusses the consequences of combining urea with PRIF 140. A way of mixing the PRIF 140 is shown in the flow chart within FIG. 12.

The PRIF/urea can be mixed in a storage tank that has a hole located at six inches from the bottom at the 12 o'clock position of the tank a second hole is located 180 degrees from initial hole or at the 6 o'clock position at the same six-inch height. A 2-4 horsepower pump is placed outside the 12 o'clock hole and then a pipe connects to an opposite side hole. This creates enough turbidity in the tank to allow the electrolytic ion to dissolve the PRIF 140 into a clear liquid. The pH will equalize to 0-1.5 and the shelf-stability is 36 months. The salt-out temperature of the liquid is between 30-32° F.

Solubility tests affirm a 10-50% (by weight) increase in the solubility limit of urea in PRIF and temperature compared to that of common solubility of mixtures having urea as a component. The electrochemical performance of the PRIF/urea combination was evaluated through cyclic voltammetry, electrochemical impedance spectroscopy, and linear sweep voltammetry. The enhanced electrochemical properties make the combination of PRIF\urea with PRIF promising for electrochemical synthesis of ammonia.

Table 2 below shows electrochemical properties of PRIF and PRIF/Urea in 3-electrode electrochemical experiments. Table 2 has some complex metrics, which are not easy to understand. Suffice to say that data from Table 2 shows both the electrochemical capacitance of PRIF increased when combined with urea, and the volumetric and gravimetric energy density also increased.

TABLE 2

| | CV Area | | Energy | Energy |
|---|---|---|---|---|
| | (A*V) in + | Capacitance | Density | Density |
| Electrolyte | 1.4 V Range | (F/cm ²) | (W*h/L) | (W*h/kg) |
| HEZ | 6.1114E−07 | 0.006175616 | 2.97082E−05 | 2.70074E−05 |
| HEZ/Urea | 6.89E−07 | 0.006963782 | 3.34997E−05 | 3.04543E−05 |

The cyclic voltammetry data of Table 2 shows that an electrochemical capacitance of PRIF 140 increases when combined with urea. Further, the volumetric and gravimetric energy density increased in the presence of urea.

The PRIF 140 by itself creates a stable electrolyte environment, and on its own has a massively reduced oxygen evolution (OER). This is an important feature: mitigating OER, and elevated electrical characteristics. The addition of urea to PRIF 140 provides in some instances a better potential usage, reduces the OER and may be better as an electrolyte in certain environments. One important observation is that adding nearly 50% by mass of a solid material like urea solubilizes perfectly, and also does not interfere in the performance of the resulting combination.

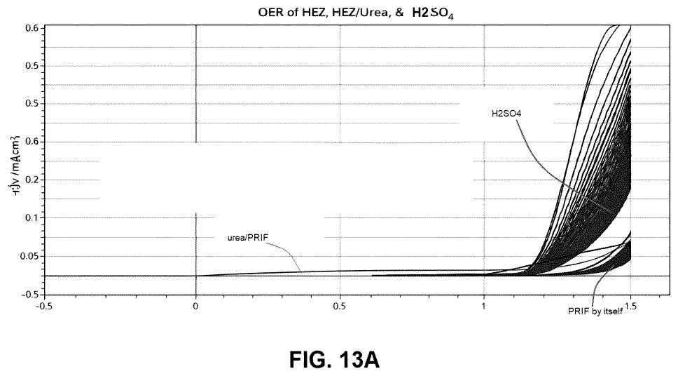

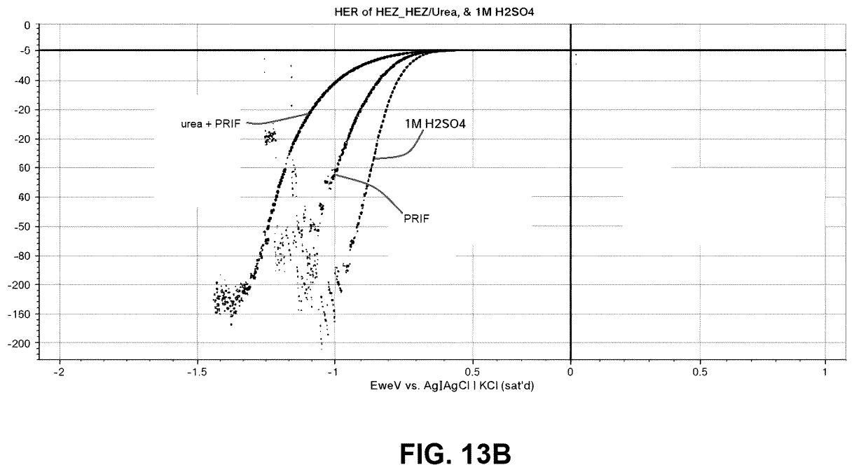

FIGS. 13A-13B also show Linear Sweep Voltammetry (LSV) for HER and OER gasification using the urea-doped PRIF 140, using the following example-only non-limiting proportions. All formulas are percentages by total mass, with the examples given in 1000-gram samples

### Formula 1:

| | |
|---|---|
| 50% | PRIF Fluid |
| 10-33% | Vanadium Sulfate (electrolyte ion) |
| Remaining | Alkyl metal salts such as magnesium or calcium or sodium |

### Formula 2:

| | |
|---|---|
| 50% | PRIF Fluid |
| 10-33% | Lithium Hydroxide (electrolyte ion) |
| Remaining | Alkyl metal salts such as magnesium or calcium or sodium |

### Formula 3:

| | |
|---|---|
| 50% | PRIF Fluid |
| 10-33% | Sodium Sulfate (electrolyte ion) |
| Remaining | Alkyl metal salts such as magnesium or calcium or sodium |

### Formula 4:

| | |
|---|---|
| 50% | PRIF Fluid |
| 50-60% | UREA (percentage to equal 100% based on different use |
| | case it is removed from the PRIF to equal 100%) |

Testing the above formulas produced FIGS. 13A-13B which affirmed that: (1) PRIF/urea is more electrochemically stable at more negative potentials during PRIF sweep to −1.5 V (vs Ag/AgCl), (2) ~50 mV difference in onset potential from PRIF (~25 mV difference between PRIF 140 & 1M H₂SO₄), (3) lower OER performance compared to 1M H₂SO₄ & PRIF, and (4) 1M H₂SO₄ durability to 100× cycles compared to PRIF/Urea.

Durability refers to a situation where after multiple uses and electrical stimulations the PRIF and PRIF/UREA still show zero difference in their EIS curves after loading and discharging. The sweeps show a lack of breakdown.

FIGS. 13A-13B show that the PRIF/urea combination is more electrochemically stable at more negative potentials during HER sweep to −1.5 V (vs Ag/AgCl), and has a ~50 mV difference in onset potential from PRIF (~25 mV difference between PRIF & 1M H₂SO₄). This in turn reinforces and affirms advantages of a PRIF/urea mixture, including as a general fertilizer.

PRIF is manufactured to have zero characterizations of water. It may have started as water but then underwent substantial changes. The PRIF\urea combination has proven convertible into an electrochemical ammonia synthesis process.

FIG. 13A shows an example LSV of PRIF 140, H₂SO₄, and PRIF/urea at intervals 10 mV/s from 0 to −1.5V (vs Ag/AgCl) for OER. Meanwhile, FIG. 13B shows an example LSV of PRIF, H₂SO₄, and PRIF/urea for OER at intervals of 10 mV/s from 0-1.5 V (vs Ag/AgCl).

From the LSV results of FIGS. 13A-13B, it can be observed that the PRIF/urea combination has lower mass transfer resistance. This is important because charged ions can transfer easily through the PRIF/urea combination due to its electrolytic capability. Further, comparable conductivity to pure PRIF 140 & 1M H₂SO₄−High Frequency Resistance=ionic+electronic resistance of electrolyte (only ~0.5 Ohms difference with 1M H₂SO₄).

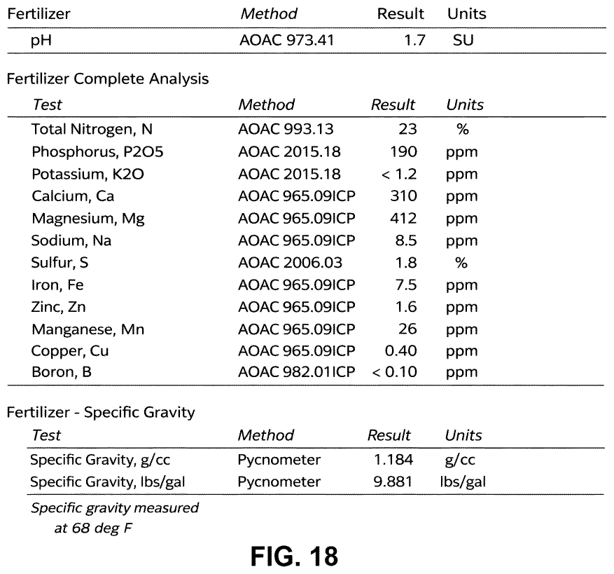

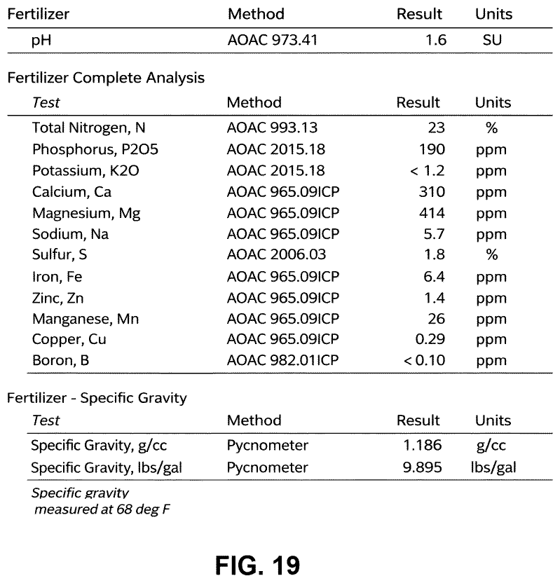

Moving to Nitrogen testing of PRIF/urea, some test results are shown in FIGS. 18-19. All testing for Nitrogen content was performed using the Dumas method (AOAC 993.13) by an independent objective third party laboratory. These test-results objective affirming that the PRIF/urea combination can provide a guaranteed amount of Nitrogen that can be made available for customers and commerce at low cost.

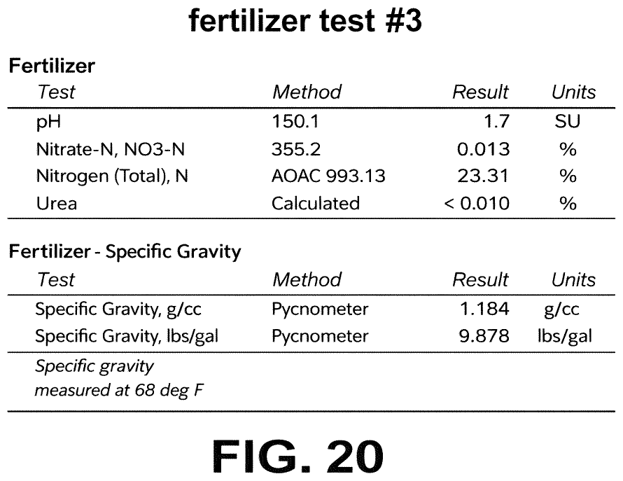

Specifically, within FIGS. 18-19, the pH (FIG. 18 pH==1.7, FIG. 19 pH==1.6) defines a saturation amount of H₁⁺ protons that allows the PRIF\urea product to remain in solution without any other additives. However, the initial urea also contains 20% carbon and since this mixture has been mixed in the PRIF, it is further helpful to prove that the H₁⁺ protons are relative. To address this, a third test-bed was conceived related to this process. This third test (FIG. 20) affirmed that the urea was separated from the carbon to actually allow for a stabilized NH3 and CO2 to be dissolved in the low pH derivative of PRIF\urea.

A common example of combining urea with plain water is shown below, mainly as an example for comparison:

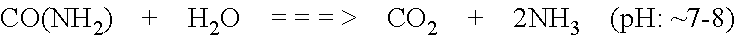

The above combination1 is well-known, and typically yields a simple urea and water blend that has a salt-out temperature of 69-70° F., having a pH of 7-8. One of numerous drawbacks to this combination is the stability is minimal due to the off-gas of the CO2 and the volatility of the ammonia (NH3).

In sharp contrast, a reaction2 combining PRIF and urea reads as follows:

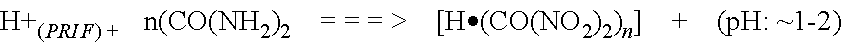

In the above combination2, the “n” represents the number of urea molecules involved in the complexation of a solvation shell. The deltaH for the specific process would be positive and large in magnitude. This also shows how a pH of the combination2 will remain low even when blended with a neutral to basic salt complex. Note how the carbon is dissolved in this combination2. A simple combustion study shows stability of dissolved carbon while also agreeing with the stoichiometric relationships above.

The formula above shows how H₁⁺ plus dissolution in common materials allows creating a solvation shell.

A combustion analysis of PRIF\urea combination in the format of a liquid fertilizer revealed C: 11.66%, H: 8.05%, and N: 23.70%. This affirms that a carbon content of the PRIF/urea blend is stable and confined inside the solvation shell. This also leads to shelf stability and reduction in storage-safety issues, as having a confined solvation shell all maintain the amount of ammonia (NH3). This is because the N content of such NH3 will not diffuse into the atmosphere during storage and transport.

PRIF Used with Silica and Sodium Chloride:

Dissolution of silica and sodium chloride into PRIF will now be discussed as a side effect to the overly saturated H₁⁺ protons. Typical silica is sold as SiO₂ or silica dioxide powder.

One potential combination-ratio (by mass): 10% SiO₂, 90% PRIF.

This solution was blended in similar reactor (set of tanks) as was used with the PRIF/urea as shown in FIG. 12. Again, a two-four horsepower pump creates enough simple turbidity in the tank to allow the silica dioxide to dissolve to a semi-clear liquid. The pH will equalize to 0-0.65.

### Sand Washing

Another usage of PRIF could be replacing common silica within wash-plants used in the purification of silica right after being mined. Sand washing refers to washing silica with the PRIF 140, thereby making the silica much easier to work with. In an example-only embodiment, one can put raw silica on a conveyer belt, hot air blowing thereupon. Then add PRIF 140, which “washes” the sand or silica and removes the impurities naturally present within silica. The resulting cleaned/processed silica becomes more efficient when converted into glass, for uses such as solar panels, regular glass, touch screens, microchips, and other uses of pure silica.

Next, after this washing, it is advantageous that some of the PRIF remains behind and the H₁⁺ free protons are left attached in a matrix to the elemental silica, which means the resulting reformed glass gains a more efficient usage. This PRIF-washed sand can also be used for computer displays, touch-screen panels, microchips and other common uses but reduced processing is needed in doing so. Some free hydrogen H₁⁺ atoms are being left behind within the silica bonds, in a way that makes the affected silicon more workable and usable, e.g. better conductivity, more sensitive conductivity value. Accordingly, the resulting glass adopts electrical characteristics that don't usually happen with other ways of washing the sand, and the pH remains between 0-0.65.

The embodiments herein thus provide a novel way to ultra-purify sand to convert it into glass, with reduced environmental hazards over previous methods.

### In-Solution Mining

In-solution mining means injecting the PRIF 140 into a large mine as a mining fluid, where the mixed (recovered) underground materials are absorbed the mining fluid. Doing so helps recovery (removal) of salt, potash, lithium, uranium, fly ash, and other in-ground elements that are not the core material being sought in the mining process. The process by adding PRIF 140 allows for the release of these minerals at extremely low cost and low energy required and brings the mining water back to neat, which means the mining water is re-usable. This makes PRIF 140 a very efficient mining additive. This in turn relates to Enhanced Oil Recovery (EOR), potentially in a shale play.

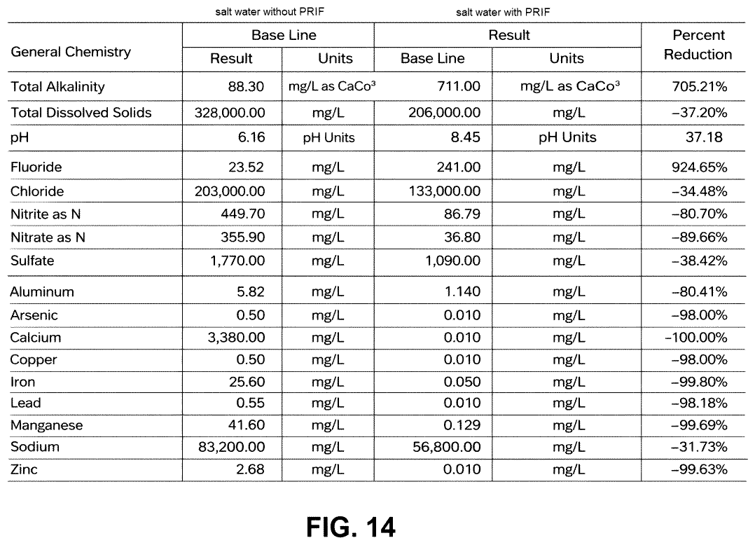

But the reverse is also true. In some instances the PRIF acts as an insoluble carrier, as shown in FIG. 14 (salt mine results). The reduction of treatment versus non-treatment shows recovery of nearly 37%-42% of Sodium and Chloride. Further, the common salt can be recovered and sold as regular food grade salt or other uses.

FIG. 14 is a reduction chart of treated versus non-treated salt water from in-solution mine. The opposite occurs when using the PRIF as a sulfur treatment in hydrocarbons, as discussed in more detail below.

### Molecular Enhancement of Hydrocarbon (M.E.H.)

During refining, a barrel of crude may be put through a distillation column. Jet fuel, diesel, kerosene, gasoline, and bunker fuel are all distillates of crude, and all contain hydrocarbons the sometimes become contaminated with sulfur. Molecular enhancements take long chains, crack them, and create shorter chains with the saturated H₁⁺ that is provided with PRIF. Doing so takes a crude oil that is sour and converts it to sweet which means the total sulfur content is less than 0.6%.

Proper use of PRIF can almost double existing MEH techniques. Either for crude improvement early on (e.g. going through a hydrocracker) OR for distillate upgrade (e.g. going through a hydro-desulfurization unit).

A distillation column takes common hydrogen (in e.g. H2 format), breaks it apart into atomic hydrogen, sends it into a crude or distillate gas stream, which then takes long chain hydrocarbons and shrinks them to short chain hydrocarbons. Since the PRIF is already mono-atomic H₁⁺ (not H2) in a liquid state. The PRIF can go directly into liquid crudes and or liquid distillates and achieve equal upgrading from the donation of its abundant hydrogen H₁⁺ (not H2) into those long chain hydrocarbons, and\or into the removal of the sulfur.

At present, oil and gas companies obtain hydrogen either from Steam Methane Reform (SMR) or from other processes. Which means they crack natural gas and then take\refine the hydrogen from the natural gas SMR unit, but this only yields H2 gas. Then, the cracker (the actual machine that does the Steam Methane Reform) or the desalinization unit has to crack the H2 gas to make it atomically available for the crude or the distillate. While a well-recognized and time-honored technique, the energy consumption aspects of SMR are becoming increasingly ineffective.

Meanwhile, using the PRIF with its pre-stabilized atomic hydrogen H₁⁺ improves MEH due to lower energy costs, increased efficiency and less moving parts, because there is no cracker or the hybrid de-sulfurization. Running a cracker eats a lot of energy.

### Distillate Upgrade (De-Sulphurization)

As a specific oil-well formation gets used up, the crude therein becomes lesser quality (e.g. more sour, perhaps lower API) in a particular formation. As that formation gets used up, the fluid pumped out of that well becomes sour (sulfur). As crude sours, its average amount of sulfur is greater than 0.6% by mass of the total barrel. The sulfur content in the barrel thus is unfortunately transferred into the distillates. The number one distillate that everybody's talking about is diesel. Diesel must have a sulfur content less than 15 PPM in the United States and less than 10 PPM in the in EU.

Getting rid of sulfur is not easy. The PRIF can do so at considerably lower costs than existing techniques.

API enhancement also helps desulphurization inherently, but if the oil is extremely sour, one must still run a distillation column device suitable for performing hydro-desulfurization. This means reboil the distillates and run them through a molecular sieve e.g. a hydrogen blanket, which then the hydrogen has an affinity for grabbing off the sulfur and the sulfur is either removed as H2S, or precipitates as a solid sulfur sludge.

Another benefit to using PRIF liquid for distillate upgrade is avoiding a blowoff of SO2 or H2S. Sulfur dioxide gas SO2 is not so bad, tolerable, but H2S is super poisonous. Meanwhile, when using the PRIF to help make a distillate, no gas-off occurs. Instead, all the unwanted elements fall out in a precipitate to the bottom of the distillate stack. This reduces H2S emission by 100%. So, using the PRIF is safer than using a hydrogen blanket or other resources used when concerns over H2S exist.

One definition of sour crude means the overall crude has greater than 0.6% sulfur. But some definitions reach 0.7%. So, when that happens e.g. in aggressive API lift, there may still be sulfur in that distillate. And because the federal mandates global mandate of sulfur, all distillates are sorted by sulfur content. Accordingly, using the PRIF 100 one can create an ultra-low sulfur diesel by removing the sulfur to be e.g. <15 PPM in USA, or <10 PPM in the EU.

If hydrogen is extremely expensive, a refiner might not do any upgrade. However, using PRIF 100, that hydrogen is authentic green hydrogen. Therefore, the value is not only in the reduction of sulfur, but also in obtaining renewable energy credits and LCFS (Low Carbon Fuel Standards) credits. This is because upgrading the fuel with authentically (not artificially\misleadingly) “green” hydrogen is extremely valuable in the marketplace right now. To be clear, the removal of the sulfur can also be removed from the by product and sold as sulfur-based fertilizers for agriculture.

Example Sulfur testing of crude oil was performed, both before and after inserting PRIF into the crude. Before PRIF, the Sulfur content was 298 ppm. After PRIF was added, the Sulfur content was 10.4 ppm.

### Summarizing PRIF Usages and Novelty

The PRIF uses are based on the fluids having stabilized H₁⁺ protons that allow it to solubilize and stabilize many types of material but also remove and purify other materials. The novelty of the PRIF comes from the process and as stated in the opening the process focus on two key methods pf electrochemical stimulation the Zeeman effect and the Dember effect.

### Zeeman Effect

In FIG. 6D the recirculators 104r and 104r introduce an oscillating magnetic field and receive an enhancement known as the Zeeman effect. One scenario involves mixing two fluids that are at opposite ranges of neutrality on the pH scale e.g. near-0 (tank1) and ~13 (tank2). However, because the recirculators 104r and 104r are in between them, the two streams do not follow standard typical acid-base reactions. Thus, the embodiments herein avoid an acid-base reaction and maintain an isolated atomic hydrogen separation as H₁⁺ known within the PRIF.

A Zeeman effect occurs where atomic energy levels in a molecule are put under an applied magnetic field. With the PRIF 140 this field is applied by the magnets (FIG. 6D) attached to the recirculators 104r, 108r. When this occurs, the molecules of the PRIF 140 are split into discrete, separated set of energy levels (orbitals). This splitting is an indication of the present of a magnetic field and can be used to calculate a strength of the magnetic field.

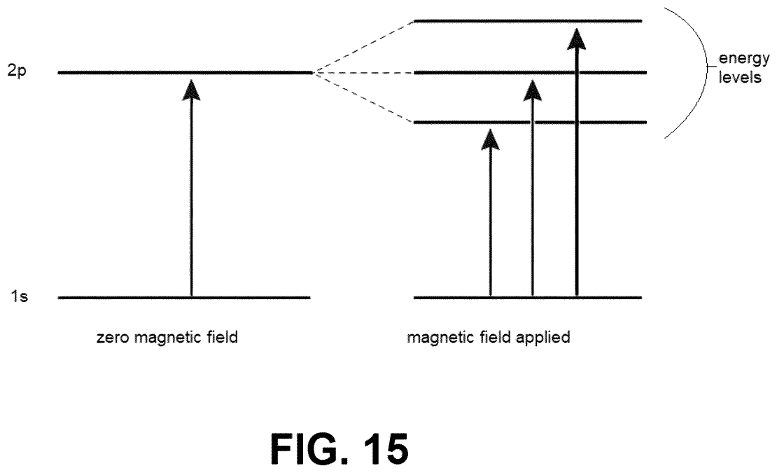

FIG. 15 illustrates a Zeeman effect on an unknown molecule being subjected to a magnetic field, with zero magnetic field on the left, and an applied magnetic field on the right. It is well known that atomic orbitals of a molecule are usually classified as one of s, p, d, and f, (sharp, principal, diffuse, fundamental) where these orbitals are typically filled based on increasing energy. The example in FIG. 15 shows an example molecule having a single energy level (p orbital) with no magnetic field. However, when a magnetic field is applied, that same molecule splits into three energy levels (p orbitals).

Within the PRIF 140, this isolation is monitored because of:
1) a first Zeeman effect on atomic hydrogen H₁⁺, and
2) a second Zeeman effect on alkali metal salts, which may be hydroxyl (OH) salts. These two effects are important, and also affect solubility, lack of solubility, and energy storage embodiments.

The Zeeman effect refers to a magnetic separation of states of atomic energy. The reactor system 100 isolates the hydrogen atom, but isolates it into an elevated free proton H₁⁺ state i.e. a proton that has had its corresponding electron pulled away.

Meanwhile, there also exists the well-known Dember effect, briefly defined as charge carrier diffusion, IOW electrons fleeing one area to go to another area. One purpose of tank1 (104) having a static magnetic field (all magnet polarities aligned) is to leverage the known Dember effect to create a localized charge carrier diffusion or accelerated carrier scattering. This Dember effect is very important to tank1 (104) to construct and destruct dipole formations depending on the band bending.

During PRIF formation, the liquid in tank1 on its way to becoming PRIF is forced through the recirculator 104r, thereby elevating an intentionally-induced Zeeman effect as stated above. The balance between the two forces is used to achieve the stretching and weakening of electron orbit (see FIG. 15), thereby freeing H₁⁺ protons. Therefore, the electrons are pushed away from the static field and the H protons are moving toward the static field, so the subatomic orbit is placed a critical moment of break. Then inside the isolated modified static “Zeeman effect” recirculator 108r, the broken protons become free of their electrons permanently. The second tank2 is the inverted moment of tank1, but without the static unified magnet field. Instead, tank2 108 has alt-magnetic fields (see FIG. 6D), thus oscillating.

The combination of fluids from the first tank 104 and second tank 108 also do not react act as an acid-base reaction. As described above, there is no neutralization or hydronium formed, as proven above in the various electrochemical impedance spectroscopy graphs (EIS). Instead, the H₁⁺ atom moves to an enhanced energy state because it's free of an electron. When the H₁⁺ atoms are mixed with the broken (OH⁻) hydroxide group that has been separated through the Zeeman/Dember effects, these H₁⁺ protons stabilize as free atoms. They do not combine into H2. Instead, they just stabilize as free atoms. Combining into H2 would later require re-breaking them apart, which the PRIF is proven to not require thus creating huge energy savings.

In this way, the Zeeman effect is acting to target individual H₁⁺ atoms and maintaining their isolation. In the PRIF-formation process the atoms are hydrogen, oxygen, and various alkyl metals. Specifically, a carrier of the hydroxide group would be calcium hydroxide, magnesium hydroxide, lithium hydroxide, potassium hydroxide and so forth. These protons are segregated from each molecular chain, so the interaction of the protons H₁⁺ with the OH− hydroxide groups is not reacting like a conventional acid-base or common molecular mixing reaction.

Moving back to the recirculators (static mixers) 104r and 108r: typically, a recirculator would be directly attached physically mounted on a tank or attached to a recirculating pump. This process allows in first tank 104 for the fluid to be going through the static field (see FIG. 6D). Then after a predetermined time, push that fluid through an oscillating magnetic field in the second recirculator 108r. The only thing that's different is the oscillating (alt-positioned) magnets attached to second tank 108 at the exterior on the second modified recirculator 108r.

An important part is the Zeeman effect is identifying the separation of atomic energy levels. The processes described herein isolate the hydrogen atom, but in a neutral state. The first tank 104 might have a pH close to zero, while the second tank 108 might have pH of ~13. Therefore, the electron has a tendency to be pushed away from the H₁⁺ atom (just a proton), and thus has a tendency to be pushed away from the static field. Then take that electron and shoot it into an alkaline metal salt.

Looking back to FIG. 1A, tank1 (104) can have a pH of near-0 and tank2 (108) can have a pH of ~13. One would think, when these mix, that they equal out or neutralize each other. However, this does not happen. An acid-base reaction does not occur. Instead, the proton doesn't react like an acid-base reaction (recombination), because it's a proton, it's not neutral. It's in an enhanced energy state because it doesn't have an electron when mixed with the hydroxide that's been separated atomically. Thus, when these fluids meet, the reaction is not common acid base reaction, instead it's only a forced collection of free protons.

The H₁⁺ stability derives partly from when the electrons start to build a solvated a shell around the imbalance of heavy amounts of free H₁⁺ protons. This again has been shown in the examples above. So instead of having an acid-base reaction, what happens is that the hydrogen H₁⁺ is actually collected and forced to be pushed together creating a hydrogen cluster or proton matrix. The other atoms such as oxygen and alkyl metals start to build an exoskeleton that is balanced by the free electrons looking to join into an available orbit for neutrality.

Another embodiment relates to developing a monocyclic cube. Electrons start to build a shell around the heavy amounts of unbalanced protons that were just dumped thereinto. So, instead of having an acid-base reaction (the acid-base reaction blocked off as indicated by Zeeman), what happens is the hydrogen is actually induced into a H₁⁺ compressed cluster. At that time, the other atoms such as calcium or the magnesium or other alkali metals build a solvation shell around the outside of the H₁⁺ cluster. Then, the electrons disperse outside the cube because there's no longer a static field in the second tank 108. Instead these electrons build an orbit around the larger molecule to become neutral. This is why there is no longer a static field on second tank 108, the Dember effect is no longer need to assist the Zeeman effect because we wanted to reconnect into a cube.

Always remembering that the outer shell is neutral to maintain stability, but the center cluster of H₁⁺ protons are highly reactive and waiting for an outside force to come and provide an activation energy to become hydrogen gas or common diatomic hydrogen that is neutral or its lowest energy moment.

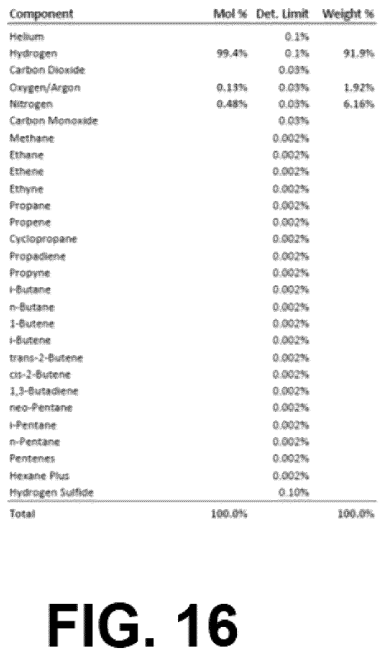

FIG. 16 shows an analysis of the PRIF being converted into a gas which affirms the above statements and assessments.

### Enthalpy of Vaporization

Another analysis of the PRIF includes reviewing the inter-molecular interactions of the molecules in the liquid phase. Enthalpy of vaporization is one way to distinguish the bulk thermodynamics quantity of the PRIF. This also shows the low amount of energy required to break the network of intermolecular interactions in the liquid.

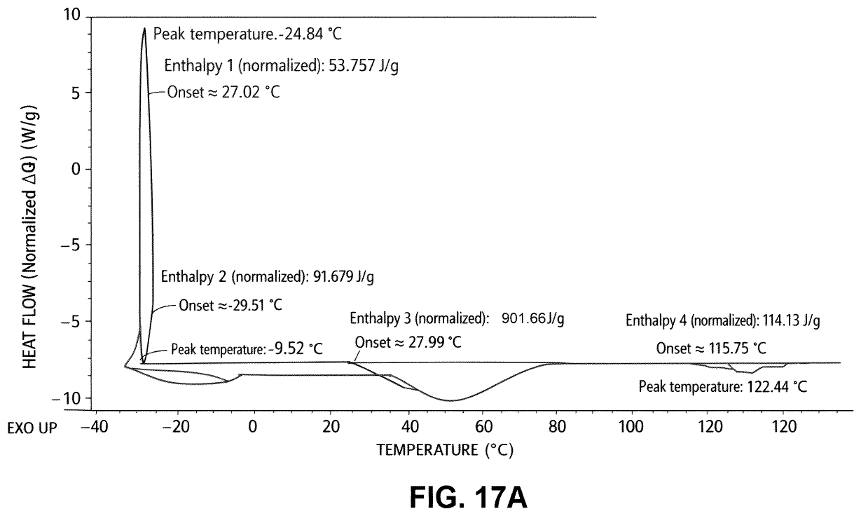

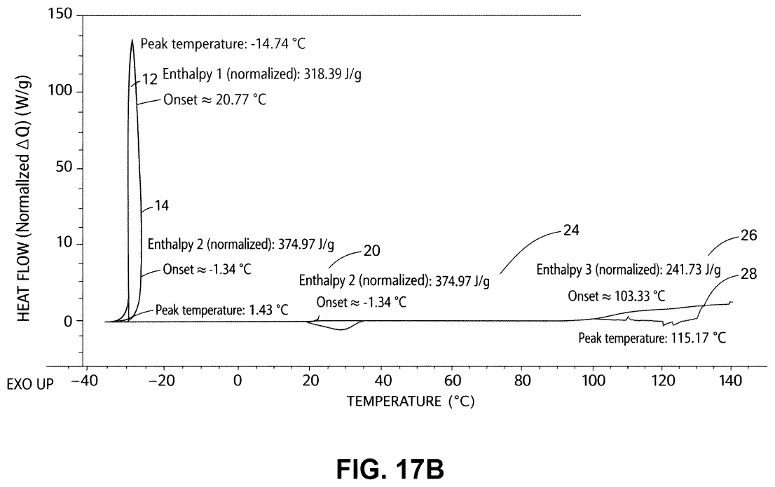

In running various test-machines to determine enthalpy of a fluid, water is often used to tune and calibrate the enthalpy machines. Compare the enthalpy of vaporization chart FIG. 17A with FIG. 17B. In comparing FIG. 17A with FIG. 17B, it is important to note that the enthalpy of vaporization of PRIF is almost two and a half times less than water.

### Disclaimer

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations, or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations, or equivalents. It is intended that the following claims define the scope of the invention and that methods and structures within the scope of these claims and their equivalents be covered thereby.

### APPENDIX A: EXAMPLE HYDROGEN-DONATING INPUT FLUIDS 101

A non-limiting list of potential types of hydrogen-donating fluids can include but is not limited to e.g., HCl—hydrochloric acid, HNO3—nitric acid, H2SO4—sulfuric acid, HBr—hydrobromic acid, HI—hydroiodic acid, HCIO4—perchloric acid, HCIO3—chloric acid, HO2C2O22H—oxalic acid, H2SO3—sulfurous acid, H20—water, HSO4—hydrogen sulfate ion, H3PO4—phosphoric acid, HNO2—nitrous acid, HF—hydrofluoric acid, HCO2H—methanoic acid, C6H5COOH—benzoic acid, CH3COOH—acetic acid, HCOOH—formic acid, C6H8O7—citric acid, C18H36O2—stearic acid, CH3OH—methyl alcohol, CH3CH2OH—ethyl alcohol, CH3 (CH2) 3OH—n-butyl alcohol, C3H80—propanol, CH3CH2CH2OH—n-propyl alcohol, (CH3) 3COH-t-butyl alcohol, CH3 (CH2)4OH—n-pentyl alcohol, and (CH3) 2CHOH—isopropyl alcohol.

### APPENDIX B: ADDITIONAL MATERIAL FOR SPECIFICATION

The following material is intended to enhance and augment the Specification.

A method of manufacturing a stable proton rich ionic fluid (PRIF) and combining it with urea can occur as follows:
driving a common liquid protic salt and water at a predetermined rate through an electrostatic field, thereby creating a first-stage fluid;
pumping the first stage fluid through a mono-polar magnetic field attached through a first static mixer for a predetermined time to form a second stage fluid;
pumping the second stage fluid through an oscillating magnetic field attached to a second static mixer for a predetermined time, thereby creating a stable H₁⁺ proton rich ionic fluid (PRIF);
combining a first predetermined amount of the PRIF with a second predetermined amount of urea; and
performing a mixing process of the combination which solubilizes the urea between 50-75% by mass.

The PRIF/urea combination could be arranged to have a pH between 1.0 and 2.0. Further, it is possible to affirm affirming that any hydrogen H₁⁺ within the PRIF/urea combination does not become diatomic hydrogen and does not need to be split again back into H₁⁺, instead staying H₁⁺. Such an affirmation could be achieve using electrochemical synthesis.

One could add a predetermined amount of PRIF to a predetermined amount of sulfur contaminated hydrocarbon or sour crude oil in a proportion of 1-25% by volume, thereby reducing the sulfur to less than 0.6% by mass.

A PRIF\urea combination could be packaged and sold as a proton based electrolyte with a <1% oxygen evolution reaction (OER). Further, that same PRIF\urea combination could be used as a direct drop in electrolyte to lead acid batteries, again having a <1% OER.

The PRIF 140 by itself can be converted into >=95% by mass common hydrogen gas. The PRIF 140 can also have an enthalpy vaporization rate of 850-1100 joules per gram.

It is possible to combine the PRIF 140 with pure silica dioxide powder to solubilize at 15-20% by mass. It is also possible to configure the PRIF\urea combination to contain 5-30% by mass nitrogen content.

It is possible to configure a PRIF\urea combination to have pH ranging from 1.0 to 2.0, and have a salt-out temperature of 25-35 F. In an embodiment, a PRIF\urea combination could act as a direct feed stock to make electrochemical ammonia synthesis while requiring no natural gas.

In an embodiment, the PRIF 140 could solubilize both urea and silica dioxide at a mixture of 70% by mass.

Next, a method of affirming H₁⁺ presence, concentration, and effect within a proton rich ionic fluid could look something like the following:
driving a common liquid protic salt and water at a predetermined rate through an electrostatic field, thereby creating a first-stage fluid;
pumping the first stage fluid through a mono-polar magnetic field through a first static mixer of a first tank for a predetermined time to form a second stage fluid;
pumping the second stage fluid through an oscillating magnetic field attached to a second static mixer of a second tank for a predetermined time, thereby creating a stable H₁⁺ proton rich ionic fluid (PRIF);
setting up a potentiostat to have a plurality of a 3-electrode probes;
applying the probes to a known concentration of the proton rich ionic fluid;
the potentiostat performing Electrochemical Impedance Spectroscopy (EIS) on the proton rich ionic fluid; and
using the graphed results of EIS, affirming that the H₁⁺ proton moves to an enhanced energy state; and
further affirming the H₁⁺ proton moved to an enhanced energy state due to being free of an electron.

From observing the graphed results of EIS, it is p[possible to affirming that any combination of the fluid from the first and second tanks does not create an acid-base reaction. This could include affirming that no acid-base neutralization occurs, and also affirming that no hydronium (H₃O⁺) is formed.

Affirming the Zeeman effect, including the splitting of spectral lines in a magnetic field, requires a combination of high-resolution optical instruments to resolve tiny energy shifts, a strong magnetic field source, and a light source.

Some instruments and components used in affirming a Zeeman effect might include a High-Resolution Spectrometer/Interferometer. Because the splitting of spectral lines is very small, a standard spectrometer is insufficient. A Fabry-Pérot Etalon (or Interferometer) would be a crucial component. These are usually placed between the light source and the detector, which splits the light into a high-resolution interference pattern (rings). A CCD Camera/Sensor might be used to capture and record the interference fringes (Zeeman rings) for analysis, often connected to a computer for real-time visualization.

A light source for affirming a Zeeman effect might include a Mercury (Hg) Lamp emitting a green light at 546.1 nm. A source for a necessary magnetic field might include an electromagnet which produces a strong, controllable magnetic field (typically up to 1 Tesla or more) to induce splitting. A gaussmeter would be helpful for measuring a strength of the magnetic field between the pole pieces.

Other components could include a polarizer/analyzer, helpful for determining a polarization state of the split light, along with an wave-pass interference filter: Filters out unwanted spectral lines, allowing only the desired wavelength (e.g., 546 nm for mercury) to pass.

Instruments for affirming the Dember effect (specifically the photo-Dember effect), involve a generation of a transient voltage or electric dipole in a semiconductor due to photo-excited carriers having different diffusion rates, typically involve ultrafast, time-resolved, and optical-pump/THz-probe setups.

Key instruments and techniques might include a femtosecond laser source for generating ultrashort optical pulses (e.g., 100 fs) to excite carriers in semiconductor samples which induce the photo-Dember voltage. A time-domain spectrometer (THz-TDS) is a primary instrument used to detect the terahertz (THz) radiation pulses emitted by the photo-Dember effect.

Semiconductor emitters may also be needed, such as narrow-gap semiconductor samples like Indium Arsenide (InAs) or Indium Antimonide (InSb) are used, chosen for their high electron mobility, which enhances the effect. Additional resources likely needed could include an optical-pump, photoconductive antennas, and metallic masks. These tools are crucial because the photo-Dember effect occurs on an ultrafast timescale (sub-picosecond), requiring rapid excitation and detection to be verified.

1. (canceled)

2. A method of manufacturing a stable proton rich ionic fluid (PRIF) and combining it with urea, comprising:
driving a common liquid protic salt and water at a predetermined rate through an electrostatic field, thereby creating a first-stage fluid;
pumping the first stage fluid through a mono-polar magnetic field attached through a first static mixer for a predetermined time to form a second stage fluid;
pumping the second stage fluid through an oscillating magnetic field attached to a second static mixer for a predetermined time, thereby creating a stable H₁⁺ proton rich ionic fluid (PRIF);
combining a first predetermined amount of the PRIF with a second predetermined amount of urea; and
performing a mixing process of the combination which solubilizes the urea between 50-75% by mass.

3. The method of claim 2, further comprising:
arranging for the PRIF/urea combination to have a pH between 1.0 and 2.0.

4. The method of claim 3, further comprising:
affirming through Electrochemical Impedance Spectroscopy (EIS) that any hydrogen H₁⁺ within the PRIF/urea combination does not become diatomic hydrogen and does not need to be split again back into H₁⁺, instead staying H₁⁺.

5. The method of claim 4, further comprising:
configuring the PRIF\urea combination to contain 5-30% nitrogen content by mass.

6. The method of claim 4, further comprising:
configuring the PRIF\urea combination to have pH ranging from 1.0 to 2.0.

7. The method of claim 4, further comprising:
configuring the PRIF\urea combination to have a salt-out temperature of 25-35 F.

8. The method of claim 4, further comprising:
configuring the PRIF\urea combination to act as a direct feed stock to make electrochemical ammonia synthesis with no natural gas.

9. The method of claim 4, further comprising:
packaging and selling the PRIF\urea combination as a proton based electrolyte with a less than 1% oxygen evolution reaction

10. A method of manufacturing a stable proton rich ionic fluid (PRIF) and combining it with urea, comprising:
driving a common liquid protic salt and water at a predetermined rate through an electrostatic field, thereby creating a first-stage fluid;
pumping the first stage fluid through a mono-polar magnetic field attached through a first static mixer for a predetermined time to form a second stage fluid;
pumping the second stage fluid through an oscillating magnetic field attached to a second static mixer for a predetermined time, thereby creating a stable H₁⁺ proton rich ionic fluid (PRIF);

11. The method of claim 10, further comprising:
packaging and selling the PRIF to be used as a direct drop in electrolyte to lead acid batteries and having a less than 1% oxygen evolution.

12. The method of claim 10, further comprising:
converting the PRIF into >=95% by mass common hydrogen gas.

13. The method of claim 10, further comprising:
configuring the PRIF to have an enthalpy vaporization rate of 850-1100 joules per gram

14. The method of claim 10, further comprising:
adding a predetermined amount of PRIF to a predetermined amount of sulfur contaminated hydrocarbon or sour crude oil in a proportion of is 1-25% by volume, thereby
reducing the sulfur to less than 0.6% by mass.

15. The method of claim 14, further comprising:
the sulfur contaminated hydrocarbon being sour crude oil.
PRIF WITH SILICA

16. The method of claim 10, further comprising:
combining the PRIF with pure silica dioxide powder to solubilize at 15-20% by mass.

17. The method of claim 16, further comprising:
the PRIF solubilizing solid both urea and silica dioxide at a mixture of 70% by mass.

18. A method of affirming H₁⁺ presence, concentration, and effect within a proton rich ionic fluid, comprising:
driving a common liquid protic salt and water at a predetermined rate through an electrostatic field, thereby creating a first-stage fluid;
pumping the first stage fluid through a mono-polar magnetic field through a first static mixer of a first tank for a predetermined time to form a second stage fluid;
pumping the second stage fluid through an oscillating magnetic field attached to a second static mixer of a second tank for a predetermined time, thereby creating a stable H₁⁺ proton rich ionic fluid (PRIF);
setting up a potentiostat to have a plurality of a 3-electrode probes;
applying the probes to a known concentration of the proton rich ionic fluid;
the potentiostat performing Electrochemical Impedance Spectroscopy (EIS) on the proton rich ionic fluid; and
using the graphed results of EIS, affirming that the H₁⁺ proton moves to an enhanced energy state; and
further affirming the H₁⁺ proton moved to an enhanced energy state due to being free of an electron.

19. The method of claim 18, further comprising:
observing the graphed results of EIS and affirming that any combination of the fluid from the first and second tanks does not create an acid-base reaction; and
using the graphed results of EIS, affirming that no acid-base neutralization occurs.

20. The method of claim 18, further comprising:
using the graphed results of EIS, affirming that no hydronium (H₃O⁺) is formed.
